(19) United States
(12) Patent Application Publication
(10) Pub. No.: US 2005/0256831 A1
(43) Pub. Date: Nov. 17, 2005

(54) Data query method employing an implication model and business dictionary

(76) Inventor: Chih-Lung Yang, Taipei City (TW)

Correspondence Address: Chih-Lung Yang, P.O. Box No. 6-57, Junghe, Taipei, 235, TW

(21) Appl. No.: 10/846,682

(22) Filed: May 17, 2004

(51) Int. Cl. G06F 7/00

(52) U.S. Cl. 707/1

(57) ABSTRACT

A data query method employing an implication model and business dictionary having characteristics that embodies employment of a common universal title of data fields and implication logic between the data fields, and with which endows business terms with systemized organization thereof, thereby realizing non-requirement for a user to understand data structure on which a database is built, while still allowing the user to achieve results of a desired query.

### BACKGROUND OF THE INVENTION

(a) Field of the Invention

The present invention relates to a data query method employing an implication model and business dictionary, and more particularly to the query method that acquires relevant data by means of logical implication relations.

(b) Description of the Prior Art

In general, a traditional data query method employs a structured query language (SQL) to query databases for relevant data. However, when employing such a method, a user must first understand data structure, field names and representative meaning on which a database is built, and moreover, query process is like a ‘black box’. Hence, when results of the query are not as anticipated, the user does not know where a problem exists, and a situation where quantity of data within a correlated table is huge frequently results in query operations being inefficient, thus creating an extremely unideal situation.

### SUMMARY OF THE INVENTION

A primary objective of the present invention is to provide a data query method employing an implication model and business dictionary, enabling rapid and efficient query of data therewith.

The aforementioned data query method utilizes implication logic between data fields, and along with a common universal title of the data fields a query result is thereby derived.

The aforementioned data query method that builds the implication logic between data fields of a data set, authorization limits to data to be fetched, and method or path to fetch data.

The aforementioned data query method fetches data fields, query conditions, a query account number, and so on, of a query a user wishes to make, and with which a correlated implication set is determined that is most pertinent and which covers all the data fields.

The aforementioned data query method, based on implication logic and definition in the implication set, fetches data from a database or data source, filters that which conforms to conditions, and sends back results to the user.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a correlated implication set constituted from implication logics and business terms.

FIG. 2 shows a logic implication block diagram according to the present invention.

### DETAILED DESCRIPTION OF THE PREFERRED EMBODIMENTS

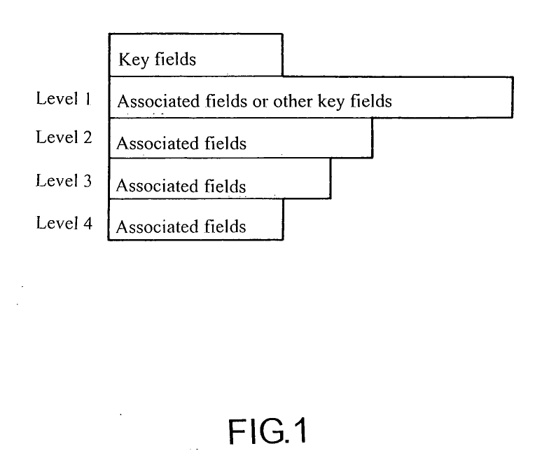

Referring to FIG. 1, which shows a correlated implication set constituted from implication logics and business terms. A logic implication relation of the present invention universally exists within a data structure, such as a primary key being the implication relation, a group of associated implication logic can constitute a correlated implication set, for instance, upon a record in lot data file recording a relation between lot number and product number, such as a lot number of certain data as A, then the product number of the lot is B with no exception, and the implication logic can be seen thereof. When fields have an equal representative lot number within the database, and have titles having identical definition, then a transitive property (A->B, B->C then A->C) can be employed, and thus deriving other values of fields therefrom. Hence, a group of business terms can be grouped in a natural correlation, and thereby take on a level relation, whereby a lower level field can be known by derivation from an upper level.

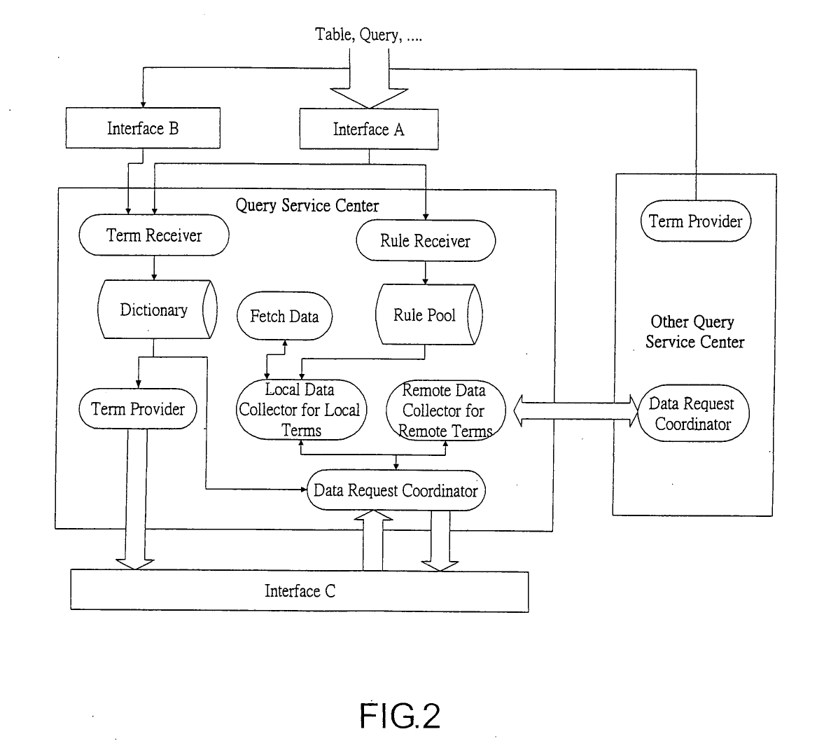

Referring to FIG. 2, which shows a logic implication block diagram according to the present invention. The query method of an embodiment of the present invention embraces following system links:

a. Interface A: definition data for the business terms, fetch method and authorization limits of access.

b. Interface B: import the business terms from another term provider of a query service center through a network.

c. Interface C: fetch the business terms from the aforementioned interface A, which can then be utilized to construct the query, and send contents of the query to a data request coordinator and display results.

d. Term Receiver: save complete definition of the term in a dictionary.

e. Rule Receiver: save complete definition of an implication rule in a rule pool.

f. Term Provider: open up the business terms for querying.

g. Local Date Collector: filter query results of local terms, and simultaneously send to the data request coordinator.

h. Remote Data Collector: send remote term and query condition to the appropriate query service center, and simultaneously receive remote query results.

i. Fetch Data: physically fetch data from the database or data source.

j. Data Request Coordinator:
1. Receive query, implication set, and analyze the term provided locally or remotely.
2. Separately submit query request to a local or a remote end.
3. Receive data set sent back from the local end or the remote end.
4. Integrate data, implement final filters.
5. Send results to the interface C.

According to the aforementioned implication theory, a query flow process of the present invention comprises following steps:
1. A user first links up with the query service center through the interface C;
2. The query is assembled based on the terms provided by the query service center;
3. Contents of the assembled query and an account number password are sent to the query service center (Data Request Coordinator);
4. After analyzing the contents of the query, if part of the term is provided by another query service center, then the query request is submitted to that center, If the term definition is provided by the query service center originally linked to, then that which is most pertinent is determined and covers the implication set of all data fields.
5. Based on the implication logic and definition in the implication set, acquire data from the data source.
6. Integrate the data sent back from the other query service center, filter that which conforms to conditions, and send back to the user.

The query method of the present invention is provided with at least following advantages:

1. Diversification of sources, not restricted to databases, moreover, tool employed for output can be an application program, a report form, a chart, and so on, and is thus provided with considerable flexibility.

2. The business terms and the authorization limits of existing implication rules can accordingly resolve problems of abuse of open database connectivity (ODBC), moreover, conditions of access to each set of data can be set for the query.

3. Process generated by the result can be analyzed, query actions of the user can be recorded, and moreover, the same query is not limited to one source database.

4. The query can be interrupted if taking a long time, and the data from business terms provided by servers of other companies can be easily integrated, moreover, the query method can be expanded to utilize the Internet, whereby the user can acquire the query result from a group of keywords within a specific application.

In addition, the user within a business can on their own accord flexibly set query contents and conditions, and moreover, information between businesses can be easily integrated, thereby realizing non-requirement to write additional programs. Furthermore, the present invention embodies originality, and is of a functional design; accordingly, a patent application is proposed herein.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A data query method employing an implication model and business dictionary comprising:
a. building of implication logic between data fields of a data set, authorization limits to data to be fetched, and a method or path to fetch data;
b. fetching of data fields, query conditions, a query account number, and so on, of a query a user wishes to make;
c. determining of a correlated implication set that is most pertinent and which covers all the data fields;
d. fetching of data from a database or data source based on implication logic and definition in the implication set, thereon filtering that which conforms to conditions, and sending back results to the user.
